(19) United States
(12) Patent Application Publication
(10) Pub. No.: US 2008/0192039 A1
(43) Pub. Date: Aug. 14, 2008

(54) Liquid crystal display and driving method thereof

(75) Inventors: Zhen-li Zhao, Shenzhen (CN); Ming-Bo Tai, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/012,868

(22) Filed: Feb. 6, 2008

(30) Foreign Application Priority Data
Feb. 9, 2007 (CN) 200710073264.X

(51) Int. Cl. G06F 3/038

(52) U.S. Cl. 345/206

(57) ABSTRACT

An exemplary liquid crystal display (2) includes a liquid crystal panel (20) and a data driving circuit (212). The liquid crystal panel includes a first substrate (22), a second substrate (23) parallel to the first substrate, a liquid crystal layer (24) interposed between the first and second substrates, and a common electrode layer (221) provided on first substrate. The second substrate includes a plurality of data lines (242). The data driving circuit includes a main circuit (213). The main circuit is connected with the common electrode layer and the data lines. The main circuit is configured to receive a brightness signal and a display signal, output a common voltage corresponding to the brightness signal to the common electrode layer, and output a gradation voltage corresponding to the brightness signal and the display signal to the data lines.

### FIELD OF THE INVENTION

The present invention relates to a liquid crystal display and a driving method of the liquid crystal display.

### GENERAL BACKGROUND

A liquid crystal display (LCD) is capable of displaying a clear and sharp image through thousands or even millions of pixels that make up the complete image. The liquid crystal display has thus been applied to various electronic equipment in which messages or pictures need to be displayed, such as mobile phones and notebook computers.

Referring to FIG. 3, a typical liquid crystal display 1 includes a liquid crystal panel 10 and a backlight module 19 facing the liquid crystal panel 10. The liquid crystal panel 10 includes an upper glass substrate 13, a lower glass substrate 14 parallel to the upper substrate 13, and a liquid crystal layer 15 interposed between the two substrates 13, 14.

A color filter layer 16 and a common electrode layer 17 are formed on a lower surface of the upper substrate 13. The color filter layer 16 includes a plurality of red (R) filter units 161, a plurality of green (G) filter units 162, and a plurality of blue (B) filter units 163. The red, greed, and blue filter units 161, 162, 163 are arranged in a pattern of repeating “RGB” filter units. The common electrode layer 17 can be made from a transparent conductive material, such as indium-tin oxide (ITO) or indium-zinc oxide (IZO).

Referring also to FIG. 4, the lower substrate 14 includes a plurality of gate lines 141 parallel to each other, a plurality of data lines 142 orthogonal to the gate lines 141, and a plurality of pixel electrodes 18 formed on an upper surface of the lower substrate 14. The gate lines 141 are configured to provide scanning voltages to the liquid crystal panel 10. The data lines 142 are configured to provide gradation voltages to the liquid crystal panel 10. The liquid crystal panel 10 defines a plurality of sub-pixels (not labeled) arranged in a matrix. Each sub-pixel includes a pixel electrode 18, the common electrode 17, liquid crystal molecules interposed between the pixel electrode 18 and the common electrode 17, and a respective filter unit. Every three adjacent sub-pixels including a red filter unit, a green filter unit, and a blue filter unit respectively make up a pixel.

The lower substrate 14 further includes a gate driving circuit 12 and a data driving circuit 11. The gate driving circuit 12 is connected with the gate lines 141, and is configured to provide the scanning voltages. The data driving circuit 11 is connected with the data lines 142, and is configured to provide the gradation voltages.

Each pixel electrode 18 is applied with a gradation voltage corresponding to external image data, and the common electrode 17 is applied with a common voltage, thereby generating an electric field therebetween. The liquid crystal molecules interposed between the pixel electrode 18 and the common electrode 17 are twisted by the electric field to let light pass therethrough in order to achieve gradation display.

Because the data driving circuit 11 can provide eight different gradation voltages to each sub-pixel, each pixel can display 256 gradations. That is, each pixel can display 256 colors.

The liquid crystal display 1 has brightness adjusting function. The common voltage applied to the common electrode 17 can be adjusted to change the electric field between the pixel electrode 18 and the common electrode 17 such that twisting angles of the liquid crystal molecules are changed. Thus, the amount of light pass through the liquid crystal layer 15 is changed, and the brightness of the liquid crystal display 1 is accordingly changed.

However, during the brightness adjusting process, the common voltage is changed. Because the common voltage is provided to all the pixels, in each sub-pixel, the difference between the gradation voltage and the common voltage is changed. Before the brightness is changed, the colors displayed in the sub-pixels shift. Because the color displayed in each pixel is mixed by the colors displayed in the three sub-pixels thereof, the color displayed in each pixel also shifts. Thus, when adjusting the brightness, the liquid crystal display 1 can not properly display desired colors. Accordingly, the display performance of the liquid crystal display 1 is impaired.

What is needed, therefore, is a liquid crystal display that can overcome the above-described deficiencies. What is also needed is a driving method of such liquid crystal display.

### SUMMARY

In one preferred embodiment, a liquid crystal display includes a liquid crystal panel and a data driving circuit. The liquid crystal panel includes a first substrate, a second substrate parallel to the first substrate, a liquid crystal layer interposed between the first and second substrates, and a common electrode layer formed on a surface facing the liquid crystal layer of the first substrate. The second substrate includes a plurality of data lines. The data driving circuit includes a main circuit. The main circuit is connected with the common electrode layer and the data lines. The main circuit is configured to receive a brightness signal and a display signal, output a common voltage corresponding to the brightness signal to the common electrode layer, and output a gradation voltage corresponding to the brightness signal and the display signal to the data lines.

Other novel features and advantages will become more apparent from the following detailed description when taken in conjunction with the accompanying drawings.

### BRIEF DESCRIPTION OF THE DRAWINGS

FIG. 1 is a side, cross-sectional view of a liquid crystal display according to an exemplary embodiment of the present invention, the liquid crystal display including a first substrate and a second substrate.

FIG. 2 is essentially an abbreviated circuit diagram of the second substrate of FIG. 1.

FIG. 3 is a side, cross-sectional view of a conventional liquid crystal display.

FIG. 4 is essentially an abbreviated circuit diagram of the second substrate of FIG. 3.

### DETAILED DESCRIPTION OF PREFERRED EMBODIMENTS

Referring to FIG. 1, a liquid crystal display 2 according to an exemplary embodiment of the present invention is shown. The liquid crystal display 2 includes a liquid crystal panel 20 and a backlight module 29 parallel to the liquid crystal panel 20. The backlight module 29 is configured to provide a plane light source for the liquid crystal panel 20. The liquid crystal panel 2 includes a first substrate 22, a second substrate 23 parallel to the first substrate 22, and a liquid crystal layer 24 interposed between the first and second substrates 22, 23.

A color filter layer 220 and a common electrode layer 221 are formed on an inner surface facing the liquid crystal layer 24 of the upper substrate 13. The color filter layer 220 includes a plurality of red (R) filter units 222, a plurality of green (G) filter units 223, and a plurality of blue (B) filter units 224. The red, greed, and blue filter units 222, 223, 224 are arranged in a pattern of repeating “RGB” filter units. The common electrode layer 221 can be made from a transparent conductive material, such as indium-tin oxide (ITO) or indium-zinc oxide (IZO).

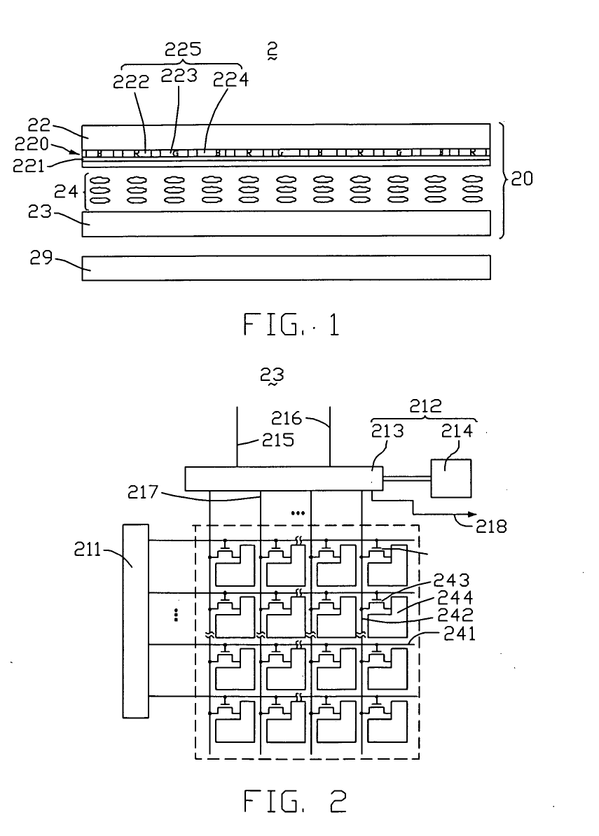

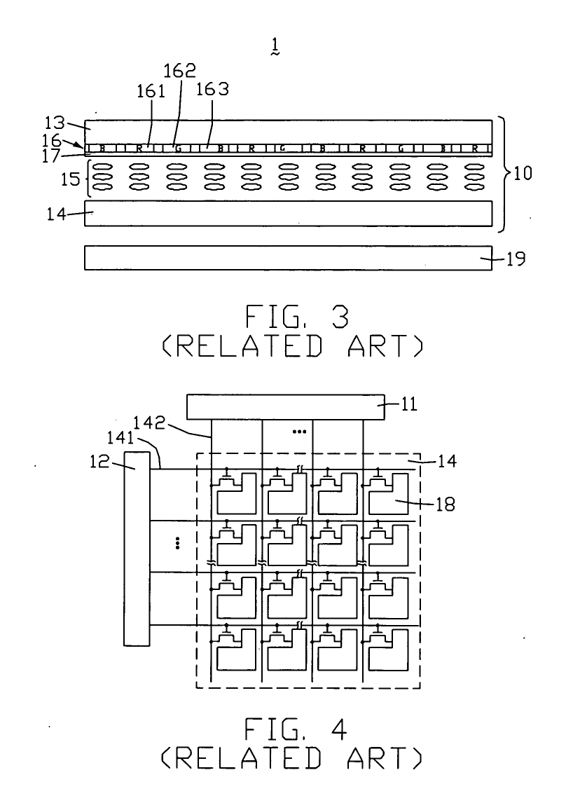

Also referring to FIG. 2, the second substrate 23 includes a plurality of parallel gate lines 241, a plurality of data lines 242 orthogonal to the gate lines 241, a plurality of thin film transistors (TFTs) 243, and a plurality of pixel electrodes 244 formed on an inner surface facing the liquid crystal layer 24 of the second substrate 23.

Each TFT 243 is provided in the vicinity of a respective point of intersection of the gate lines 241 and the data lines 242, and corresponds to a pixel electrode 244. Each TFT 243 includes a gate electrode (not labeled) connected to a corresponding gate line 241, a source electrode (not labeled) connected to a corresponding data line 242, and a drain electrode (not labeled) connected to the respective pixel electrode 244.

Each pixel electrode 244 corresponds to a filter unit. The pixel electrode 244, the common electrode layer 221, the respective filter unit, and liquid crystal molecules interposed between the pixel electrode 244 and the common electrode layer 221 form a sub-pixel (not labeled). Every three adjacent sub-pixels including a red filter unit, a green filter unit, and a blue filter unit respectively make up a pixel.

Each pixel electrode 244 is applied with a gradation voltage corresponding to external image data, and the common electrode layer 221 is applied with a common voltage, thereby generating an electric field therebetween. The liquid crystal molecules interposed between the pixel electrode 244 and the common electrode layer 221 are twisted by the electric field to let light pass therethrough in order to achieve gradation display.

The liquid crystal display 2 further includes a gate driving circuit 211 and a data driving circuit 212. The gate driving circuit 211 is connected with the gate lines 241. The data driving circuit 212 includes a main circuit 213 and a database 214. The main circuit 213 includes an input 215, a brightness signal terminal 216, a plurality of data outputs 217, and a common voltage output 218. The data outputs 217 are connected to the data lines 242 respectively. The common voltage output 218 is connected to the common electrode layer 221.

The brightness signal terminal 216 is configured to receive external input brightness signals. The input 215 is configured to receive external input display signals. The database 214 stores correction display signals one-to-one corresponding to the inputted display signals under different brightness signals. The common voltage output 218 is configured to provide common voltages to the common electrode layer 221. The data outputs 217 are configured to provide gradation voltages to the data lines 242.

The brightness signals are configured to control a brightness of the liquid crystal display 2, and include three brightness values: B1, B2, and B3. The common voltages outputted by the common voltage output 218 include three values: Vcom1, Vcom2, and Vcom3, which one-to-one correspond to the three brightness values B1, B2, and B3 respectively. B1 represents a standard brightness signal, and corresponds to Vcom1. B2 and B3 are used in brightness adjusting function of the liquid crystal display 2.

Each display signal includes gradation data of an image of a frame. In the display signal, the gradation of each pixel has 64 values, S1˜S64. The data driving circuit 212 can provide four gradation voltages, V1, V2, V3, and V4, and output the gradation voltages through the data outputs 217. The four gradation voltages cooperate with the standard common voltage Vcom1 to make each sub-pixel display four gradations. Thus, each pixel can display the 64 gradations of the display signal. That is, the gradation data of each frame of the display signal is proper when the liquid crystal display 2 works under the standard brightness B1.

The correction display signal includes different gradations from the display signal, and is configured to correct the gradations of the display signal when the brightness signal is B1 or B2 so as to make an image displayed by the liquid crystal display 2 when the common voltage is Vcom2 or Vcom3 approximate to a desired image as much as possible.

When the liquid crystal display 2 works, the brightness signal terminal 216 receives an external brightness signal. The input 215 receives an external display signal. The main circuit 213 accesses the database 214 to obtain a correction display signal corresponding to the brightness signal and the display signal. The common voltage output 218 outputs a common voltage corresponding to the brightness signal to the common electrode layer 221. The data outputs 217 each output a gradation voltage corresponding to the correction display signal to the corresponding data line 242.

In summary, the liquid crystal display 2 has brightness adjusting function and gradation voltage correction function. When the common voltage is changed in order to change the brightness, the correction display signals are provided, thus the pixels can properly display desired colors. Therefore, the display quality of the liquid crystal display 2 is improved. Moreover, because the gradation voltage outputted after correction is still one of the original gradation voltages and the displayed colors approximate to ideal colors, no additional gradation voltage is added. Therefore, the cost of the liquid crystal display 2 is not increased.

The correction display signals stored in the database 214 is set as follows.

In step 1, necessary parameters are obtained. Three common voltages outputted under the three brightness values B1, B2, and B3, the four gradation voltages V1, V2, V3, and V4, transmission spectrums of the liquid crystal layer 24 under all combinations of the three common voltages and the four gradation voltages, transmission spectrums of the common electrode layer 221 and the pixel electrodes 244, a spectrum of the backlight module 29, and a table of spectral tristimulus values are obtained.

In step 2, tristimulus values displayed in the sub-pixels corresponding to the red, green, and blue filter units 222, 223, 224 under all combinations of the three common voltages and the four gradation voltages is calculated according to the follow formula (1):

$$\{ \begin{matrix}X = k \sum S ( λ ) τ ( λ ) \overline{x} ( λ ) Δλ \\ Y = k \sum S ( λ ) τ ( λ ) \overline{y} ( λ ) Δλ \\ Z = k \sum S ( λ ) τ ( λ ) \overline{z} ( λ ) Δλ ,\end{matrix} \qquad ( 1 )$$

wherein x̅(λ), y̅(λ), z̅(λ) represents the spectrum tristimulus values, S(λ) represents the spectrum of the backlight module 29, τ(λ) represents the transmission spectrums, k is a constant, and λ represents wavelengths.

Twelve tristimulus values can be worked out according to the formula (1). The tristimulus values of the sub-pixels corresponding to the red filter units 222 can be represented as (X_{Rab}, Y_{Rab}, Z_{Rab}), the tristimulus values of the sub-pixels corresponding to the green filter units 223 can be represented as (X_{Gab}, Y_{Gab}, Z_{Gab}), and the tristimulus values of the sub-pixels corresponding to the blue filter units 224 can be represented as (X_{Bab}, Y_{Bab}, Z_{Bab}), wherein “a” is 1, 2, or 3, and corresponds to the common voltages Vcom1, Vcom2, and Vcom3, and “b” is 1, 2, 3, or 4, and corresponds to the gradation voltages V1, V2, V3, and V4.

In step 3, the correction display signal corresponding to each chromaticity coordinate under different common voltages is backward calculated according to chromaticity coordinates of 64 gradations which can be displayed in the pixels.

The correction of a gradation voltage of one pixel under the common Vcom2 is taken as an example below.

Supposing the chromaticity coordinate of each of the 64 gradations is (xᵢ, yᵢ, wherein i=1,2, . . . , 64). When no correction is performed, the tristimulus values of the sub-pixels corresponding to the red filter units 222 are represented as (X_{Ri0}, Y_{Ri0}, Z_{Ri0}), the tristimulus values of the sub-pixels corresponding to the green filter units 223 are represented as (X_{Gi0}, Y_{Gi0}, Z_{Gi0}), and the tristimulus values of the sub-pixels corresponding to the blue filter units 224 are represented as (X_{Bi0}, Y_{Bi0}, Z_{Bi0}). After the correction is performed, the tristimulus values of the sub-pixels corresponding to the red filter units 222 are represented as (X_{Ri}, Y_{Ri}, Z_{Ri}), the tristimulus values of the sub-pixels corresponding to the green filter units 223 are represented as (X_{Gi}, Y_{Gi}, Z_{Gi}), and the tristimulus values of the sub-pixels corresponding to the blue filter units 224 are represented as (X_{Bi}, Y_{Bi}, Z_{Bi}). Because the correction is merely for the colors, the brightness of the liquid crystal display 2 does not change after the correction. Thus, the following equations can be established:

$$\{ \begin{matrix}{Y}_{Ri} + {Y}_{Gi} + {Y}_{Bi} = {Y}_{Ri 0} + {Y}_{Gi 0} + {Y}_{Bi 0} \\ \frac{{Y}_{Ri} + {Y}_{Gi} + {Y}_{Bi}}{( {X}_{Ri} + {X}_{Gi} + {X}_{Bi} ) + ( {Y}_{Ri} + {Y}_{Gi} + {Y}_{Bi} ) + ( {Z}_{Ri} + {Z}_{Gi} + {Z}_{Bi} )} = {y}_{i} \\ \frac{{X}_{Ri} + {X}_{Gi} + {X}_{Bi}}{( {X}_{Ri} + {X}_{Gi} + {X}_{Bi} ) + ( {Y}_{Ri} + {Y}_{Gi} + {Y}_{Bi} ) + ( {Z}_{Ri} + {Z}_{Gi} + {Z}_{Bi} )} = {x}_{i} .\end{matrix}$$

Ranges of the unknown values (X_{Ri}, Y_{Ri}, Z_{Ri}), (X_{Gi}, Y_{Gi}, Z_{Gi}), (X_{Bi}, Y_{Bi}, Z_{B}i) are (X_{Rab}, Y_{Rab}, Z_{Rab}), (X_{Gab}, Y_{Gab}, Z_{Gab}), (X_{Bab}, Y_{Bab}, Z_{Bab}) which are worked out in step 2, wherein a=2, and b=1, 2, 3, or 4.

By the above method, all correction display signals under the common voltage Vcom2 can be worked out. In the same way, correction display signals under other common voltages can be worked out.

A driving method of the liquid crystal display 2 is described as follows.

In step 1, the brightness signal terminal 216 receives a brightness signal, and the input 215 receives a display signal.

In step 2, the main circuit 213 accesses the database 214 to obtain a correction display signal corresponding to the brightness signal and the display signal.

In step 3, the common voltage output 218 outputs a common voltage corresponding to the brightness signal, and the data outputs 217 output gradation voltages corresponding to the correction display signal to the data lines 242 respectively.

The brightness signal received by the brightness signal terminal 216 can be changed such that the common voltage outputted by the common voltage output 218 is changed following the change of the brightness signal. Thus, the electric field applied to the liquid crystal molecules is changed, and light passing through the liquid crystal layer 24 is changed. As a result, the brightness of the liquid crystal display 2 is changed.

When the liquid crystal display 2 works under the standard brightness, the brightness signal terminal 216 receives the standard brightness signal. The main circuit 213 accesses the database 214 to obtain a correction display signal which is the same as the received display signal. That is, the display signal needs not be corrected. The main circuit 213 generates a gradation voltage according to the correction display signal, and a standard common voltage. The common voltage output 218 outputs the standard common voltage, and the data outputs 217 output the gradation voltage.

When adjusting the brightness of the liquid crystal display 2, the common voltage is adjusted according to the brightness signal, and the gradation voltage of the display signal is adjusted with the change of the common voltage. After receiving the display signal, the main circuit 213 accesses the database 214 to obtain a correction display signal corresponding to the brightness signal and the display signal. The main circuit 213 generates a gradation voltage according to the obtained correction display signal, and a common voltage corresponding to the brightness signal. The data outputs 217 output the gradation voltage, and the common voltage output 218 outputs the common voltage. Due to circuit design limitations, the gradation voltage is still one of the four gradation voltages V1, V2, V3, and V4, and approximates to an ideal value at utmost.

In summary, in the driving method of the liquid crystal display 2, when the common voltage is changed in order to change the brightness, the correction display signals are provided, thus the pixels can properly display desired colors. Therefore, the display quality of the liquid crystal display 2 is improved. Moreover, because the gradation voltage outputted after correction is still one of the original gradation voltages and the displayed colors approximate to ideal colors, no additional gradation voltage is added. Therefore, the cost of the liquid crystal display 2 is not increased.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display comprising:
a liquid crystal panel comprising a first substrate, a second substrate parallel to the first substrate, a liquid crystal layer interposed between the first and second substrates, and a common electrode layer provided on the first substrate, the second substrate comprising a plurality of data lines; and
a data driving circuit comprising a main circuit, the main circuit connected with the common electrode layer and the data lines, the main circuit configured to receive a brightness signal and a display signal, output a common voltage corresponding to the brightness signal to the common electrode layer, and output a gradation voltage corresponding to the brightness signal and the display signal to the data lines.

2. The liquid crystal display of claim 1, wherein the data driving circuit further comprises a database, the database configured to store correction display signals corresponding to combinations of different brightness signals and different display signals.

3. The liquid crystal display of claim 2, wherein the main circuit is further configured to access the database to obtain a correction display signal corresponding to the brightness signal and the display signal after receiving the brightness signal and the display signal, generate the common voltage corresponding to the brightness signal and the gradation voltage corresponding to the correction display signal.

4. The liquid crystal display of claim 1, wherein the main circuit comprises a plurality of inputs configured to receive the display signal, and a brightness signal terminal configured to receive the brightness signal.

5. The liquid crystal display of claim 4, wherein the main circuit further comprises a plurality of data outputs, and a common voltage output, the data outputs connected to the data lines respectively and configured to output the gradation voltage to the data lines, the common voltage output connected to the common electrode layer and configured to output the common voltage to the common electrode layer.

6. The liquid crystal display of claim 1, wherein the second substrate further comprises a plurality of pixel electrodes.

7. The liquid crystal display of claim 6, wherein the second substrate further comprises a plurality of gate lines.

8. The liquid crystal display of claim 7, further comprising a gate driving circuit connected with the gate lines.

9. The liquid crystal display of claim 1, wherein the liquid crystal panel further comprises a color filter provided between the first substrate and the common electrode layer.

10. The liquid crystal display of claim 1, wherein the common electrode layer is made from one of indium tin oxide and indium zinc oxide.

11. A driving method of the liquid crystal display of claim 1, the driving method comprising:
providing a brightness signal and a display signal to the main circuit; and
the main circuit outputting a common voltage corresponding to the brightness signal to the common electrode layer, and outputting a gradation voltage corresponding to the brightness signal and the display signal to the data lines.

12. The driving method of claim 11, wherein the data driving circuit further comprises a database, the database configured to store correction display signals corresponding to combinations of different brightness signals and different display signals, the driving method further comprising:
the main circuit accessing the database to obtain a correction display signal corresponding to the brightness signal and the display signal after receiving the brightness signal and the display signal; and
the main circuit generating the common voltage corresponding to the brightness signal and the gradation voltage corresponding to the correction display signal.

13. The driving method of claim 11, wherein when the brightness signal is a standard brightness signal, the corresponding common voltage is a standard common voltage.

14. The driving method of claim 13, wherein when the brightness signal is a standard brightness signal, the correction display signal is the same as the display signal.

15. The driving method of claim 11, wherein the liquid crystal display further comprises a color filter, and defines a plurality of pixels arranged in a matrix, each pixel comprising three sub-pixels, the color filter comprising a plurality of red filter units, green filter units, and blue filter units, the three sub-pixels corresponding to a red filter unit, a green filter unit, and a blue filter unit respectively, and a gradation of each pixel being combined by gradations of the three sub-pixels thereof.

16. The driving method of claim 15, wherein the display signal and correction display signal each comprises gradation data of all the sub-pixels.

17. The driving method of claim 16, wherein the gradation voltage generated by the main circuit cooperates with the common voltage to make the pixels display.

18. The driving method of claim 17, wherein if the brightness of any one of the pixels under the display signal is Y₀, and the brightness of the pixel under the correction display signal is Yᵢ, Y₀ is equal to Yᵢ.

19. The driving method of claim 18, wherein when the liquid crystal display works under the standard common voltage, supposing the chromaticity coordinate of a gradation i is (xᵢ, yᵢ),
$$\{ \begin{matrix}{Y}_{Ri} + {Y}_{Gi} + {Y}_{Bi} = {Y}_{Ri 0} + {Y}_{Gi 0} + {Y}_{Bi 0} \\ \frac{{Y}_{Ri} + {Y}_{Gi} + {Y}_{Bi}}{( {X}_{Ri} + {X}_{Gi} + {X}_{Bi} ) + ( {Y}_{Ri} + {Y}_{Gi} + {Y}_{Bi} ) + ( {Z}_{Ri} + {Z}_{Gi} + {Z}_{Bi} )} = {y}_{i} \\ \frac{{X}_{Ri} + {X}_{Gi} + {X}_{Bi}}{( {X}_{Ri} + {X}_{Gi} + {X}_{Bi} ) + ( {Y}_{Ri} + {Y}_{Gi} + {Y}_{Bi} ) + ( {Z}_{Ri} + {Z}_{Gi} + {Z}_{Bi} )} = {x}_{i} ,\end{matrix}$$
wherein (X_{Ri}, Y_{Ri}, Z_{Ri}) represent tristimulus values of sub-pixels corresponding to the red filter units under the correction display signal, (X_{Gi}, Y_{Gi}, Z_{Gi}) represent tristimulus values of sub-pixels corresponding to the green filter units under the correction display signal, (X_{Bi}, Y_{Bi}, Z_{Bi}) represent tristimulus values of sub-pixels corresponding to the blue filter units, and (Y_{Ri0}, Y_{Gi0}, Y_{Bi0}) are values of “Y” of the tristimulus values of sub-pixels corresponding to the red, green, and blue filter units under the display signal.
